(19) United States
(12) Patent Application Publication
(10) Pub. No.: US 2026/0369908 A1
(43) Pub. Date: Nov. 19, 2026

(54) CONNECTOR

(71) Applicant: SUMITOMO WIRING SYSTEMS, LTD., Mie (JP)

(72) Inventor: Naoya AKIMOTO, Mie (JP)

(21) Appl. No.: 19/677,696

(22) Filed: May 14, 2026

(30) Foreign Application Priority Data
May 16, 2025 (JP) 2025-082445

(51) Int. Cl. H01R 12/58

(52) U.S. Cl. CPC H01R 12/585

(57) ABSTRACT

A connector is assembled with an enclosure of an electrical device while being passed through an opening formed in the enclosure and connected to a board arranged in the enclosure. The connector includes a housing, a terminal to be held in the housing, and a terminal protecting member to be attached to the housing. The terminal includes a board connecting portion to be passed through a through hole formed in the terminal protecting member and connected to the board. The board connecting portion includes an edge portion along an insertion direction into the through hole and a press-fit protrusion projecting from the edge portion and to be press-fit to an inner surface of the through hole.

### CROSS-REFERENCE TO RELATED APPLICATIONS

This application is based on and claims priority from Japanese Patent Application No. 2025-082445, filed on May. 16, 2025, with the Japan Patent Office, the disclosure of which is incorporated herein in its entirety by reference.

### TECHNICAL FIELD

The present invention relates to a connector.

### BACKGROUND

For example, a connector provided with a terminal protecting member (auxiliary member in Japanese Patent Laid-open Publication No. 2024-130722) for protecting a terminal is described in Japanese Patent Laid-open Publication No. 2024-130722. The connector is provided with a housing, the terminal to be held in the housing and the terminal protecting member to be attached to the housing. The connector is, for example, assembled with an enclosure of an electrical device while being passed through an opening formed in the enclosure. The terminal of the connector includes an extending portion extending outward from the housing. The extending portion of the terminal includes a board connecting portion to be connected to a board arranged in the enclosure of the electrical device. When the connector is assembled with the enclosure of the electrical device, the extending portion of the terminal and the terminal protecting member are inserted into the opening of the enclosure. At this time, the contact of the extending portion of the terminal with an edge part of the opening of the enclosure is prevented by the terminal protecting member.

### SUMMARY

In the connector as described above, the board connecting portion of the terminal is loosely inserted into a through hole of the terminal protecting member. That is, a gap is set between the board connecting portion of the terminal and the terminal protecting member. In this way, the board connecting portion is positioned to a certain extent by the through hole in a direction orthogonal to an insertion direction, but not positioned with respect to the through hole in the insertion direction. Thus, the position of the board connecting portion may deviate in the insertion direction. As a result, the connection reliability of the board connecting portion and the board may be reduced.

The present disclosure aims to provide a connector capable of suppressing a position deviation of a board connecting portion of a terminal in an insertion direction into a terminal protecting member.

The present disclosure is directed to a connector to be assembled with an enclosure of an electrical device while being passed through an opening formed in the enclosure and to be connected to a board arranged in the enclosure, the connector being provided with a housing, a terminal to be held in the housing, and a terminal protecting member to be attached to the housing, the terminal including a board connecting portion to be passed through a through hole formed in the terminal protecting member and connected to the board, and the board connecting portion including an edge portion along an insertion direction into the through hole and a press-fit protrusion projecting from the edge portion and to be press-fit to an inner surface of the through hole.

According to the connector of the present disclosure, it is possible to suppress a position deviation of the board connecting portion of the terminal in the insertion direction into the terminal protecting member.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a state where a terminal protecting member is removed in a connector of one embodiment.

FIG. 2 is a partial side view of the connector in the embodiment.

FIG. 3 is an end view along 3-3 of FIG. 2.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

1. The connector of the present disclosure is to be assembled with an enclosure of an electrical device while being passed through an opening formed in the enclosure and to be connected to a board arranged in the enclosure, and provided with a housing, a terminal to be held in the housing, and a terminal protecting member to be attached to the housing, the terminal including a board connecting portion to be passed through a through hole formed in the terminal protecting member and connected to the board, and the board connecting portion including an edge portion along an insertion direction into the through hole and a press-fit protrusion projecting from the edge portion and to be press-fit to an inner surface of the through hole.

According to this configuration, the board connecting portion is fixed to the through hole by press-fitting the press-fit protrusion of the board connecting portion in the terminal to the inner surface of the through hole of the terminal protecting member. Thus, a position deviation of the board connecting portion in the insertion direction can be suppressed. As a result, the connection reliability of the terminal to the board can be improved.

2. In [1] described above, the press-fit protrusion may have an inclined surface inclined to the insertion direction in an end part in the insertion direction.

According to this configuration, the press-fit protrusion has the inclined surface inclined to the insertion direction in the end part in the insertion direction of the press-fit protrusion. In this way, the press-fit protrusion is easily press-fit to the inner surface of the through hole by the inclined surface, resulting in contribution to an improvement in workability in assembling the terminal protecting member with the housing.

3. In [1] or [2] described above, the press-fit protrusion may have a perpendicular surface perpendicular to the insertion direction in an end part in an opposite direction opposite to the insertion direction.

According to this configuration, the press-fit protrusion has the perpendicular surface perpendicular to the insertion direction in the end part of the press-fit protrusion in the opposite direction opposite to the insertion direction. In this way, when the press-fit protrusion is press-fit into the through hole of the terminal protecting member, a location where a pushing jig is brought into contact can be set on the perpendicular surface of the press-fit protrusion. Therefore, the press-fit protrusion can be press-fit into the through hole of the terminal protecting member while the deformation of the terminal is suppressed as compared to the case where the location where the pushing jig is brought into contact is set in a part different from the press-fit protrusion.

4. In any one of [1] to [3] described above, the board connecting portion may be in the form of a flat plate, the edge portion may be included on each of both edges in a width direction of the board connecting portion, and the press-fit protrusion may be provided on each of the both edges in the width direction.

According to this configuration, the board connecting portion is in the form of a flat plate. The edge portion provided with the press-fit protrusion is included on each of the both edges in the width direction of the board connecting portion. That is, the press-fit protrusion is provided on each of the both edges in the width direction of the board connecting portion. Therefore, the board connecting portion can be more suitably fixed to the through hole by press-fitting the press-fit protrusions respectively provided on the both edges in the width direction of the board connecting portion to the inner surface of the through hole of the terminal protecting member.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each figure. "Perpendicular" in this specification means not only strictly perpendicular, but also substantially perpendicular within a range in which functions and effects in this embodiment are achieved. Further, "facing each other" in this specification indicates that surfaces or members are at positions in front of each other, and means not only a case where the surfaces or members are at positions perfectly in front of each other, but also a case where the surfaces or members are partially in front of each other. Further, "facing each other" in this specification means both a case where another member different from two parts is interposed between the two parts and a case where nothing is interposed between the two parts. The present invention is not limited to these illustrations, but is represented by claims and intended to include all changes in the scope of claims and in the meaning and scope of equivalents.

### Configuration of Connector 10

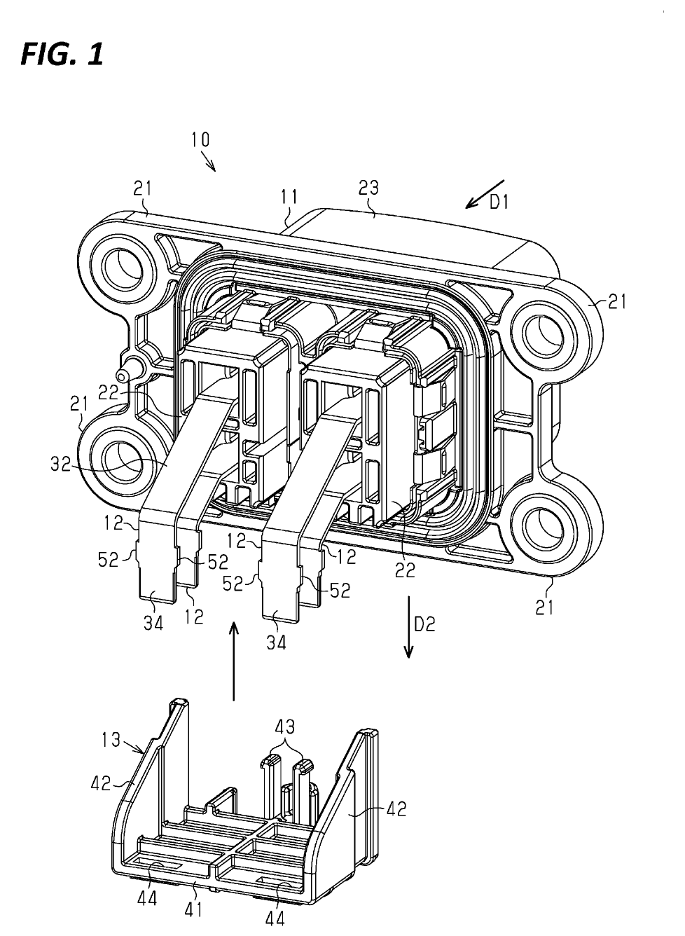

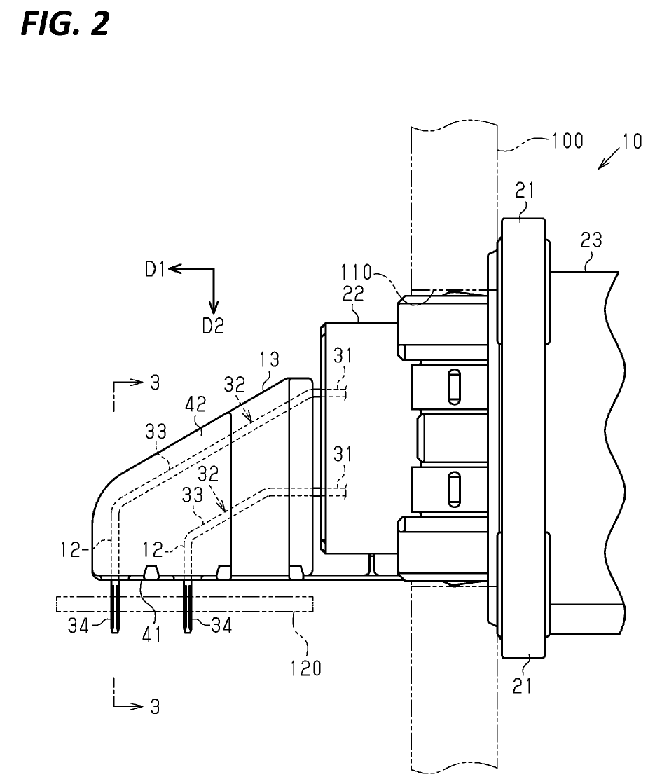

As shown in FIGS. 1 and 2, a connector 10 of an embodiment is provided with a housing 11, terminals 12 to be held in the housing 11 and a terminal protecting member 13 to be attached to the housing 11.

As shown in FIG. 2, the connector 10 is, for example, assembled with an enclosure 100 of an electrical device to be installed in a vehicle while being passed through an opening 110 formed in the enclosure 100. Note that, in FIG. 2, a left side of the enclosure 100 shows an internal space of the enclosure 100 and a right side of the enclosure 100 shows an external space of the enclosure 100. In an assembled state of the enclosure 100, a part of the connector 10 is arranged inside the enclosure 100.

### Configuration of Housing 11

As shown in FIGS. 1 and 2, the housing 11 of the connector 10 is provided with fixing portions 21, holding portions 22 and a fitting portion 23. The fixing portions 21, the holding portions 22 and the fitting portion 23 are formed integrally with each other. The fixing portions 21 are fixed to an outer side surface of the enclosure 100 by unillustrated bolts or the like. The holding portions 22 hold, for example, a plurality of the terminals 12. The fitting portion 23 is formed to extend to an outer side of the enclosure 100 from the fixing portions 21. An unillustrated mating connector is fit into the fitting portion 23.

### Configuration of Terminals 12

Each terminal 12 is, for example, made of metal. Each terminal 12 is, for example, formed as a flat plate by press-working a metal plate material. Each terminal 12 is provided with a base portion 31 to be arranged in the holding portion 22 and an extending portion 32 extending to the outside of the housing 11 from the base portion 31. The base portion 31 extends, for example, along a fitting direction D1 of the mating connector into the fitting portion 23. With the connector 10 assembled with the enclosure 100, the extending portion 32 is arranged inside the enclosure 100.

As shown in FIG. 2, the extending portion 32 includes an inclined portion 33 extending obliquely to the fitting direction D1 from the base portion 31 and a board connecting portion 34 extending from the tip of the inclined portion 33. Each of the inclined portion 33 and the board connecting portion 34 is in the form of a flat plate. The board connecting portion 34 extends along a direction (insertion direction D2) perpendicular to the fitting direction D1. The inclined portion 33 is formed between the base portion 31 and the board connecting portion 34 in the terminal 12. The board connecting portion 34 is connected to a board 120 arranged in the enclosure 100 by soldering or the like. Note that the board 120 is fixed to an unillustrated board fixing portion provided in the enclosure 100 inside the enclosure 100.

### Configuration of Terminal Protecting Member 31

As shown in FIGS. 1 and 2, the terminal protecting member 13 is configured to protect the extending portions 32 of the terminals 12. The terminal protecting member 13 is inserted into the inside of the enclosure 100 through the opening 110, together with the extending portions 32 of the terminals 12. The terminal protecting member 13 is a member made of an insulating material such as synthetic resin. The terminal protecting member 13 is supported on a side where the extending portions 32 of the terminals 12 extend by the housing 11.

The terminal protecting member 13 is provided with a terminal holding portion 41 for holding the extending portions 32 of the terminals 12, a pair of protection walls 42 extending from the terminal holding portion 41 and locking portions 43 to be locked to the housing 11. By locking the locking portions 43 to the housing 11, the terminal protecting member 13 is assembled with the housing 11.

The terminal holding portion 41 of the terminal protecting member 13 is substantially in the form of a flat plate perpendicular to the insertion direction D2. The terminal holding portion 41 is facing the board 120 in the insertion direction D2. The terminal holding portion 41 is provided with through holes 44, into which the board connecting portions 34 are inserted in the insertion direction D2. The through hole 44 is a hole penetrating through the terminal holding portion 41 along the insertion direction D2. A plurality of the through holes 44 are provided to correspond to the number of the terminals 12 in this embodiment.

The pair of protection walls 42 of the terminal protecting member 13 cover the extending portions 32 of the plurality of terminals 12 from both sides in a width direction. The terminal protecting member 13 is configured to prevent the extending portions 32 of the terminals 12 from contacting an edge part of the opening 110 and the like during the insertion of the connector 10 into the opening 110 by the terminal holding portion 41 and the respective protection walls 42. Each protection wall 42 extends, for example, perpendicularly from the terminal holding portion 41.

### Configuration of Press-Fit Protrusions 52

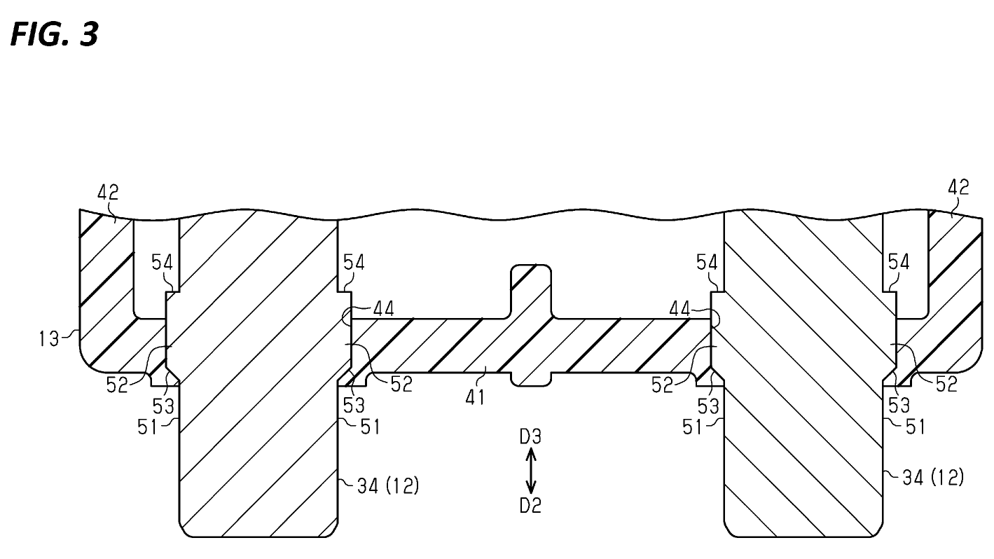

As shown in FIG. 3, the board connecting portion 34 of the terminal 12 includes edge portions 51 along the insertion direction D2 into the through hole 44 and press-fit protrusions 52 projecting from the edge portions 51. The edge portion 51 provided with the press-fit protrusion 52 is included on each of both edges in the width direction of the board connecting portion 34. That is, the press-fit protrusions 52 are respectively provided on the both edges in the width direction of the board connecting portion 34. Note that the width direction of the board connecting portion 34 is a direction orthogonal to each of a plate thickness direction of the board connecting portion 34 and the insertion direction D2. The press-fit protrusions 52 project outward in the width direction from the both edges (respective edge portions 51) in the width direction of the board connecting portion 34. The press-fit protrusions 52 are press-fit to the inner surface of the through hole 44 of the terminal holding portion 41 in the terminal protecting member 13. In this way, the board connecting portion 34 is fixed to the terminal holding portion 41. In this way, position deviations of the board connecting portion 34 in the insertion direction D2 and an opposite direction D3 opposite to the insertion direction D2 with respect to the terminal holding portion 41 are prevented.

The press-fit protrusion 52 has an inclined surface 53 in an end part in the insertion direction D2 of the press-fit protrusion 52. The inclined surface 53 is inclined inward in the width direction in the insertion direction D2. When the board connecting portion 34 is inserted into the through hole 44 in the insertion direction D2, the press-fit protrusions 52 are easily press-fit to the inner surface of the through hole 44 by the inclined surfaces 53.

The press-fit protrusion 52 has a perpendicular surface 54 in an end part in the direction D3 opposite to the insertion direction D2. The perpendicular surface 54 is a surface perpendicular to the insertion direction D2. For example, by pushing the perpendicular surface 54 in the insertion direction D2 by an unillustrated pushing jig, the board connecting portion 34 is press-fit into the through hole 44. That is, the pushing jig is brought into contact with the perpendicular surface 54 of the press-fit protrusion 52 when the board connecting portion 34 is press-fit. Note that, in a configuration in which the press-fit protrusion 52 is not formed with the perpendicular surface 54 as a comparison configuration, a location where the pushing jig is brought into contact has to be set in a part different from the press-fit protrusion 52 of the terminal 12 (e.g. a corner part where the board connecting portion 34 and the inclined portion 33 are connected or the like). In this case, the terminal 12 may be deformed when the board connecting portion 34 is press-fit.

### Effects of Embodiment

Effects of this embodiment are described below.
1. The board connecting portion 34 of the terminal 12 is provided with the edge portions 51 along the insertion direction D2 into the through hole 44 of the terminal protecting member 13 and the press-fit protrusions 52 projecting from the edge portions 51 and to be press-fit to the inner surface of the through hole 44. According to this configuration, the press-fit protrusions 52 of the board connecting portion 34 in the terminal 12 are press-fit to the inner surface of the through hole 44 of the terminal protecting member 13, whereby the board connecting portion 34 is fixed to the through hole 44. Therefore, a position deviation of the board connecting portion 34 in the insertion direction D2 can be suppressed. As a result, the connection reliability of the terminal 12 to the board 120 can be improved. Further, for example, even if the terminal 12 is deformed by the terminal protecting member 13 unintentionally contacting the extending portion 32 of the terminal 12 when the terminal protecting member 13 is assembled, the board connecting portion 34 can be corrected to return to a proper position by press-fitting and fixing the board connecting portion 34 to the through hole 44.
2. The press-fit protrusion 52 has the inclined surface 53 inclined to the insertion direction D2 in the end part in the insertion direction D2 of the press-fit protrusion 52. In this way, the press-fit protrusion 52 is easily press-fit to the inner surface of the through hole 44 by the inclined surface 53, resulting in contribution to an improvement in workability when the terminal protecting member 13 is assembled with the housing 11.
3. The press-fit protrusion 52 has the perpendicular surface 54 perpendicular to the insertion direction D2 in the end part of the press-fit protrusion 52 in the opposite direction D3 opposite to the insertion direction D2. In this way, the location where the pushing jig is brought into contact in press-fitting the press-fit protrusion 52 into the through hole 44 of the terminal protecting member 13 can be set on the perpendicular surface 54 of the press-fit protrusion 52. Therefore, the press-fit protrusion 52 can be press-fit into the through hole 44 of the terminal protecting member 13 while the deformation of the terminal 12 is suppressed as compared to the case where the location where the pushing jig is brought into contact is set in a part different from the press-fit protrusion 52 in the terminal 12.
4. The board connecting portion 34 is in the form of a flat plate. The edge portion 51 provided with the press-fit protrusion 52 is included on each of the both edges in the width direction of the board connecting portion 34. That is, the press-fit protrusions 52 are respectively provided on the both edges in the width direction of the board connecting portion 34. Therefore, the press-fit protrusions 52 respectively provided on the both edges in the width direction of the board connecting portion 34 are press-fit to the inner surface of the through hole 44 of the terminal protecting member 13, whereby the board connecting portion 34 can be more suitably fixed to the through hole 44.

### Other Embodiments

The above embodiment can be modified and carried out as follows. The above embodiment and the following modifications can be combined with each other and carried out without technically contradicting.

In the press-fit protrusion 52 of the above embodiment, at least one of the inclined surface 53 and the perpendicular surface 54 may be omitted.

In the board connecting portion 34 of the above embodiment, the press-fit protrusion 52 may be provided only on one edge portion 51 in the width direction of the board connecting portion 34.

In the extending portion 32 of the terminal 12 of the above embodiment, the inclined portion 33 may be omitted.

The board connecting portion 34 may not be in the form of a flat plate.

The number of the terminals 12 is not limited to that of the above embodiment and can be appropriately changed according to the configuration of the connector 10.

The shape of the pair of protection walls 42 in the terminal protecting member 13 is not limited to that of the above embodiment and may be appropriately changed according to the shape of the extending portions 32 of the terminals 12 and the like.

The embodiment disclosed this time is illustrative in all aspects, and the present invention is not limited to these illustrations. That is, the scope of the present invention is represented by claims and intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector to be assembled with an enclosure of an electrical device while being passed through an opening formed in the enclosure and to be connected to a board arranged in the enclosure, comprising:
a housing;
a terminal to be held in the housing; and
a terminal protecting member to be attached to the housing,
the terminal including a board connecting portion to be passed through a through hole formed in the terminal protecting member and connected to the board, and
the board connecting portion including an edge portion along an insertion direction into the through hole and a press-fit protrusion projecting from the edge portion and to be press-fit to an inner surface of the through hole.

2. The connector of claim 1, wherein the press-fit protrusion has an inclined surface inclined to the insertion direction in an end part in the insertion direction.

3. The connector of claim 1, wherein the press-fit protrusion has a perpendicular surface perpendicular to the insertion direction in an end part in an opposite direction opposite to the insertion direction.

4. The connector of claim 1, wherein:
the board connecting portion is in the form of a flat plate,
the edge portion is included on each of both edges in a width direction of the board connecting portion, and
the press-fit protrusion is provided on each of the both edges in the width direction.
